(19) United States
(12) Patent Application Publication
(10) Pub. No.: US 2021/0035708 A1
(43) Pub. Date: Feb. 4, 2021

(54) CABLE WITH VARIABLE STIFFNESS

(71) Applicant: Apple Inc., Cupertino, CA (US)

(72) Inventors: Aaron A. Oro, Palo Alto, CA (US); Christopher S. Graham, San Francisco, CA (US); Eric S. Jol, San Jose, CA (US); Karl Ruben F. Larsson, Los Altos, CA (US); Timothy J. Rasmussen, San Jose, CA (US); Paul J. Thompson, Mountain View, CA (US); Joseph I. Briskey, Aptos, CA (US)

(73) Assignee: Apple Inc., Cupertino, CA (US)

(21) Appl. No.: 16/983,476

(22) Filed: Aug. 3, 2020

Related U.S. Application Data
(60) Provisional application No. 62/882,250, filed on Aug. 2, 2019.

(51) Int. Cl. H01B 7/04; H01B 7/02; H01B 7/00

(52) U.S. Cl. CPC H01B 7/04; H01R 13/58; H01B 7/0081; H01B 7/0275

(57) ABSTRACT

A cable can include a cable core surrounded by an outer sleeve having a uniform thickness and further having a first longitudinal section having a first stiffness (e.g., corresponding to a flexible cable), a second longitudinal section having a second stiffness (e.g., corresponding to a rigid cable), and a third longitudinal section between the first and second longitudinal sections, where the second stiffness is greater than the first stiffness and where a stiffness of the third longitudinal section varies between the first stiffness and the second stiffness. The second longitudinal section can provide strain relief for the cable.

### CROSS-REFERENCES TO RELATED APPLICATIONS

This application claims the benefit of U.S. Provisional Application No. 62/882,250, filed Aug. 2, 2019, the disclosure of which is incorporated herein by reference for all purposes.

### BACKGROUND

This disclosure relates generally to cables such as electrical cables used to transmit power and/or data and in particular to a cable having variable stiffness along its length.

An electrical cable generally includes one or more conductive wires that can be used to transmit power and/or data between devices connected to the two ends of the cable. The cable is wrapped in an outer sleeve or sheath that provides electrical insulation and protection from the elements. Where the cable includes multiple conductive wires, the outer sleeve also holds the wires together, making the cable easier to manage.

Depending on the particular application, an end of a cable can be connected into a connector (e.g., a plug-type connector) or an active electronic device having contacts to which the wires of the cable are connected. It is well known that bending of the cable near the termination point may cause unwanted strain on the wire connections, which may lead to cable failure. Accordingly, it is common to provide a strain relief sleeve made of a stiff material around the end region of the cable. The stiff material creates a localized increase in the bending resistance of the cable, thereby relieving strain on the wire connections.

### SUMMARY

Existing strain relief sleeves are generally formed as a separate structure placed around the outer cable sleeve. In addition to making the cable locally stiffer, the strain relief sleeve also makes the cable thicker at the ends. In some instances, the added thickness may not be desired.

Certain embodiments of the present invention relate to cables having strain relief regions integrated into the cable sleeve. In some embodiments, a cable can include a cable core having one or more signal conductors, such as electrically conductive wires. The cable core can be surrounded by an outer sleeve having a uniform thickness and further having a first longitudinal section having a first stiffness (e.g., corresponding to a flexible cable), a second longitudinal section having a second stiffness (e.g., corresponding to a rigid cable), and a third longitudinal section between the first and second longitudinal sections, where the second stiffness is greater than the first stiffness and where a stiffness of the third longitudinal section varies between the first stiffness and the second stiffness. In some embodiments, the second longitudinal section can be an end section of the cable.

In some embodiments, the outer sleeve can include a first layer made of a soft material and a second layer made of a stiff material. In the first longitudinal section, a thickness of the first layer can exceed a thickness of the second layer, while in the second longitudinal section, the thickness of the second layer exceeds the thickness of the first layer, so that the total thickness of the outer sleeve is constant along the length of the cable. In the third longitudinal section, the thickness of the first layer and the thickness of the second layer can vary along the length of the third longitudinal section such the total thickness of the outer sleeve is constant. The first layer can be inboard of (i.e., closer to the core than) the second layer, or the second layer can be inboard of the first layer.

In some embodiments, the outer sleeve can be formed of a mixed material comprising a stiff polymer and a soft polymer. In the first longitudinal section, the mixed material can contains a first ratio of the stiff polymer to the soft polymer, while in the second longitudinal section, the mixed material contains a second ratio of the stiff polymer to the soft polymer, where the first ratio is lower than the second ratio. In the third longitudinal section, the mixed material can contain a ratio of the stiff polymer to the soft polymer that varies along the length of the third longitudinal section.

According to some embodiments, a cable can include a cable core comprising one or more signal conductors (such as electrically conductive wire). The cable core can be surrounded by an outer sleeve having a uniform thickness and further having a central section having a first stiffness, an end section at each end having a second stiffness, and a transition section between each end section and the central section, wherein the second stiffness is greater than the first stiffness and wherein a stiffness of the transition section varies between the first stiffness and the second stiffness.

According to some embodiments, an assembly can include an electronic component having a housing and a cable disposed outside the housing. The cable can include a cable core comprising one or more signal conductors (e.g., electrically conductive wires) that extend through the housing and couple to the electronic component. The cable core can be surrounded by an outer sleeve having a uniform thickness and further having a central section having a first stiffness, an end section abutting the housing and having a second stiffness, and a transition section between the central section and the end section, wherein the second stiffness is greater than the first stiffness and wherein a stiffness of the transition section varies between the first stiffness and the second stiffness. In some embodiments, the end section and the transition section can provide strain relief where the cable connects to the housing.

The following detailed description together with the accompanying drawings will provide a better understanding of the nature and advantages of the claimed invention.

### BRIEF DESCRIPTION OF THE DRAWINGS

FIG. 1 shows a longitudinal cross-section view of a cable with integrated strain relief according to some embodiments.

FIG. 2 shows a longitudinal cross-section view of another cable with integrated strain relief according to some embodiments.

FIG. 3 shows a longitudinal cross-section view of another cable with integrated strain relief according to some embodiments.

FIG. 4 shows a simplified example of an assembly according to some embodiments.

FIG. 5 shows a simplified cross-section view of an assembly using a conventional strain relief technique.

FIG. 6 shows a simplified cross section view of an assembly according to some embodiments.

FIG. 7 shows a simplified cross section view of an assembly according to some embodiments.

### DETAILED DESCRIPTION

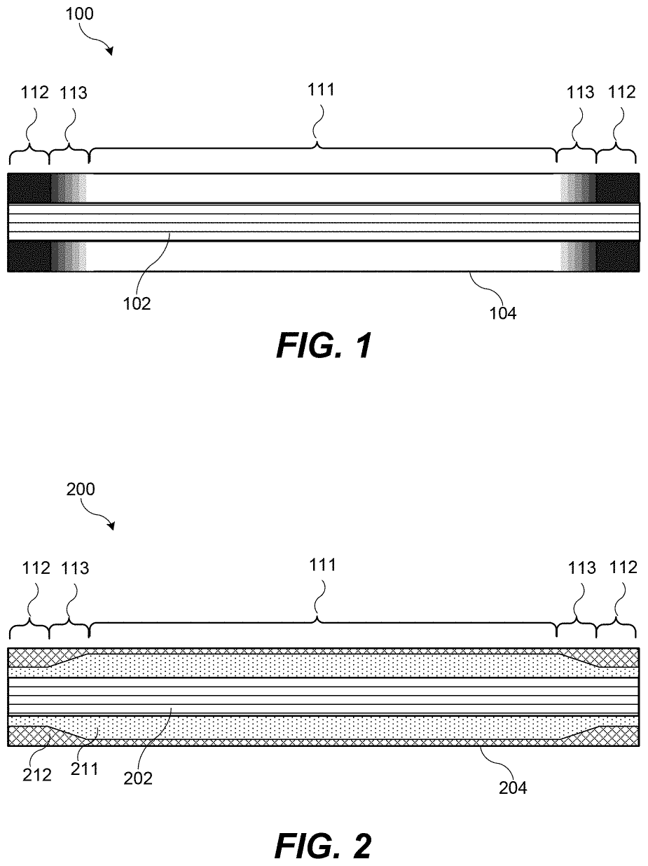

FIG. 1 shows a longitudinal cross-section view of a cable 100 with integrated strain relief according to some embodiments. Cable 100 can be an electrical cable of arbitrary length and can have, for example, a cylindrical cross section. Cable 100 can have a core 102 that includes one or more conductive wires, which may be insulated from each other. The conductive wires can be, e.g., copper wire or the like and can have any gauge desired. Any number of wires can be included. For example, cable 100 can be usable as a USB cable having four wires to conduct power, ground, and a pair of differential data signals. The particular number, arrangement, and gauge of the wires in cable 100 can be varied as desired.

Cable 100 also has an outer sleeve 104 that can be made of polymers such as a thermoplastic elastomer (TPE), a thermoplastic urethane (TPU), or a thermosetting plastic. Numerous examples of suitable polymers are known in the art. Different longitudinal sections 111, 112, 113 of sleeve 104 can have different stiffness (or resistance to bending); in FIG. 1, stiffness is indicated using gray scale, with black corresponding to highest stiffness and white corresponding to lowest stiffness. Central section 111 has a low stiffness, end sections 112 have a high stiffness, and “transition” sections 113 have a variable stiffness that gradually transitions between the high stiffness of end section 112 and the low stiffness of central section 111.

Various metrics can be used to define stiffness. For example, minimum bend radius, defined as the smallest radius at which the cable can be bent without a kink, is one well-known measure of cable stiffness, and a minimum bend radius can be defined relative to the cable diameter. Increasing bend radius corresponds to increasing stiffness. Depending on the particular cable design, the minimum bend radius might be e.g., 8 to 12 times the cable diameter. In some embodiments, the stiffness of central section 111 may constrain the minimum bend radius.

End sections 112 can be significantly stiffer than central section 111. For example, end sections 112 can be stiff enough to provide strain relief when ends of the wires of core 102 are connected to a device. In some embodiments, end sections 112 can be rigid, or end sections 112 can have a minimum bend radius that is 10 or 100 (or more) times the minimum bend radius of central section 111. Transition sections 113 can have a stiffness that increases monotonically from the low stiffness of central section 111 to the high stiffness of end section 112, thereby providing a smooth transition between rigid and flexible sections of cable 100.

In some embodiments, sleeve 104 having variable stiffness can be manufactured using an extrusion process. For example, the polymers used to make sleeve 104 can include a mixture of a stiffer material and more flexible (also referred to as softer) material. By varying the relative proportion of stiff and flexible materials as a cable is extruded, regions of greater or lesser stiffness can be created. For instance, end section 112 can have a greater amount of stiff material than flexible material so that end section 112 can be substantially rigid to resist bending of cable 100. Central section 111 have a greater amount of flexible material than stiff material so that central section 111 can be substantially pliable to allow bending of cable 100. Transition section 113 can be a region of cable 100 where stiff and flexible materials gradually vary in relative concentration between end section 113 and central section 111. For instance, transition section 113 can be a region of cable 100 where the amount of stiff material decreases from the amount used in end section 112 to the amount used in central section 111 while the amount of flexible material increases from the amount used in end section 112 to the amount used in central section 111. In some embodiments, the amount of stiff material varies inversely with the amount of flexible material.

In some embodiments, instead of using a mixture of materials, a cable sleeve having variable stiffness can be a multilayer sleeve incorporating two (or more) layers of different stiffness. FIG. 2 shows a longitudinal cross-section view of another cable 200 with integrated strain relief according to some embodiments. Like cable 100, cable 200 can be an electrical cable of arbitrary length and can have, for example, a cylindrical cross section. Cable 200 can have a core 202 that includes one or more conductive wires, which may be insulated from each other. The particular number, arrangement, and gauge of the wires can be varied as desired.

Cable 200 also has an outer sleeve 204 that can be made of polymers such as a thermoplastic elastomer (TPE), a thermoplastic urethane (TPU), or a thermosetting plastic. Numerous examples of suitable polymers are known in the art. Similarly to cable 100, different longitudinal sections 111, 112, 113 of cable 200 can have different stiffness, with central section 111 having low stiffness, end sections 112 having high stiffness, and sections 113 having a variable stiffness that gradually transitions between the high stiffness of end section 112 and the low stiffness of central section 111.

In cable 200, the regions of different stiffness are created by forming outer sleeve 204 from two layers of material having different stiffness. For example, outer sleeve 204 can be a multi-layered sleeve that includes two layers: a soft layer 211 made of a material that is relatively flexible (small minimum bend radius) and a stiff layer 212 made of a material that has a structural rigidity that is greater than that of soft layer 211 (high minimum bend radius). In some embodiments, the relative thickness of stiff layer 212 and soft layer 211 can be modified to create three regions of sleeve 204: a stiff end section 112, a flexible central section 111, and a transition section 113. As shown, in end section 112, stiff layer 212 is thicker than soft layer 211, so that end section 112 can be substantially rigid to resist bending of cable 200. In central section 111, soft layer 111 is thicker than stiff layer 212, so that central section 111 can be substantially flexible to allow bending of cable 200. Transition section 113 can be a region of cable 200 where stiff and soft layers 212 and 211 gradually vary in relative thicknesses between stiff end section 112 and flexible central section 111. The total thickness of stiff layer 212 and soft layer 211 can be constant along the length of cable 200, so that when stiff layer 212 increases in thickness, soft layer 211 decreases in thickness, and vice versa. Thus, within transition section 113, the thickness of stiff layer 212 decreases from end section 112 to central section 111 while the thickness of soft layer 211 increases from end section 112 to central section 111. Cable 200 can be manufactured using processes such as extrusion processes with controlled layer thicknesses.

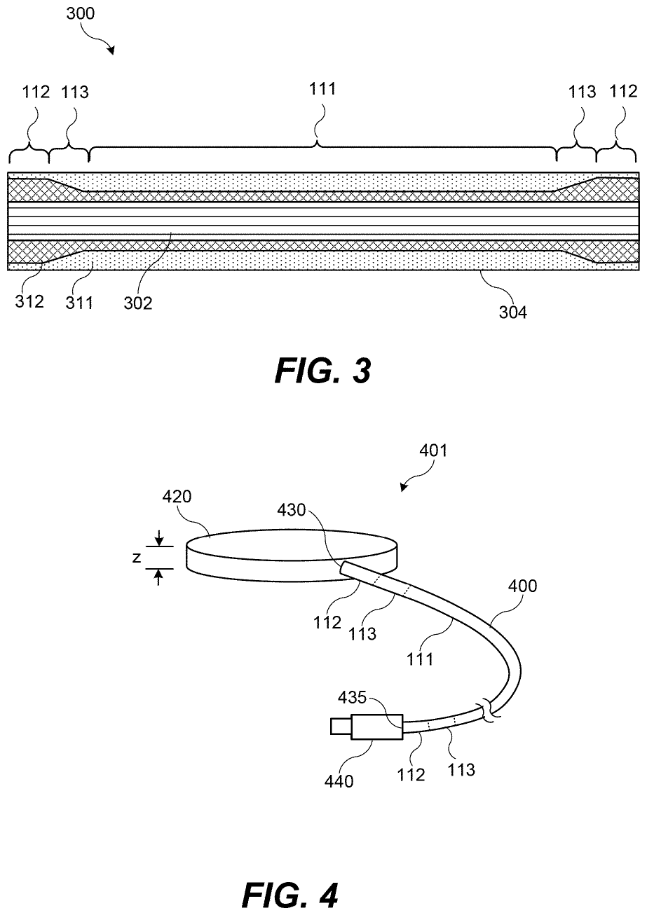

In cable 200, soft layer 211 is inboard of (i.e., closer to core 202 than) stiff layer 212. In other embodiments, the order of layers can be varied. For example, FIG. 3 shows a shows a longitudinal cross-section view of another cable 300 with integrated strain relief according to some embodiments. Cable 300 is generally similar to cable 200 and can be an electrical cable of arbitrary length and can have, for example, a cylindrical cross section. Cable 300 can have a core 302 that includes one or more conductive wires, which may be insulated from each other. The particular number, arrangement, and gauge of the wires can be varied as desired.

Cable 300 also has an outer sleeve 304 that can be made of polymers such as a thermoplastic elastomer (TPE), a thermoplastic urethane (TPU), or a thermosetting plastic. Numerous examples of suitable polymers are known in the art. Similarly to cable 100 or cable 200, different longitudinal sections 111, 112, 113 of cable 300 can have different stiffness, with central section 111 having low stiffness, end sections 112 having high stiffness, and sections 113 having a variable stiffness that gradually transitions between the high stiffness of end section 112 and the low stiffness of central section 111.

In cable 300, the regions of different stiffness are created by forming outer sleeve 304 from two layers of material having different stiffness, similarly to cable 200 except that the order of layers is reversed. For example, outer sleeve 304 can be a multi-layered sleeve that includes two layers: an outer soft layer 311 made of a material that is relatively flexible (small minimum bend radius) and an inner stiff layer 312 made of a material that has a structural rigidity that is greater than that of soft layer 311 (high minimum bend radius). In some embodiments, the relative thickness of stiff layer 312 and soft layer 311 can be modified to create three regions of sleeve 304: a stiff end section 112, a flexible central section 111, and a transition section 113. As shown, in end section 112, stiff layer 312 is thicker than soft layer 311, so that end section 112 can be substantially rigid to resist bending of cable 300. In central section 111, soft layer 311 is thicker than stiff layer 312, so that central section 111 can be substantially flexible to allow bending of cable 300. Transition section 113 can be a region of cable 300 where stiff and soft layers 312 and 311 gradually vary in relative thicknesses between stiff end section 112 and flexible central section 111. The total thickness of stiff layer 312 and soft layer 311 can be constant along the length of cable 300, so that when stiff layer 312 increases in thickness, soft layer 311 decreases in thickness, and vice versa. Thus, within transition section 113, the thickness of stiff layer 312 decreases from end section 112 to central section 111 while the thickness of soft layer 311 increases from end section 112 to central section 111. Cable 300 can be manufactured using processes such as extrusion processes with controlled layer thicknesses.

In some embodiments, the length of end section 112 and transition section 113 of a cable such as cable 100, cable 200, or cable 300 can be tailored to achieve a certain bend radius to mitigate strain of the cable. For example, for a USB cable, each end section 112 can be about 2 cm long, and each transition section 113 can have the same length or a similar length, while central section 111 can extend the rest of the length of the cable. The total length of the cable can be as long as desired. In some embodiments, cable manufacturing can include extruding a cable with alternating stiff sections having a first length (e.g., 5 cm) and flexible sections having a second length (e.g., 0.5 m to 2 m), with transition sections between each stiff section and flexible section. The cable can be cut in the middle of the stiff sections to produce lengths of cable with stiff end sections and flexible center sections. In other embodiments, a stiff section may be provided at only one end of a cable, or a stiff section may be provided somewhere along the length of the cable away from the end in addition to or instead of at one or both ends.

In some embodiments, cables such as cable 100, cable 200, or cable 300 can be used to provide strain relief without an increase in cable thickness. FIG. 4 shows a simplified example of an assembly 401 according to some embodiments. Cable 400 has one end captively coupled to an electronic device 420. Electronic device 420 can be, for example, an active electronic device such as a wireless charging puck for a portable electronic device. One end 430 of cable 400 is inserted through the housing of electronic device 420 so that individual wires of cable 400 can be connected to components inside electronic device 420. In some embodiments, the other end 435 of cable 400 can be connected to a connector 440 such as a USB connector (e.g., a Type A USB connector or USB-C connector). Those skilled in the art will be familiar with techniques for electrically connecting cables, and a detailed description is omitted. Those skilled in the art will also appreciate that it may be desirable to provide strain relief at ends 430 and 435 of cable 400.

According to some embodiments, strain relief can be provided by using a cable 400 whose sleeve has a stiff end section as described above disposed at ends 430 and 435. For instance, cable 400 can be an implementation of cable 100 of FIG. 1 or cable 200 of FIG. 2 or cable 300 of FIG. 3, with a stiff end section 112 disposed abutting end 410, a flexible central section 111, and a transition section 113 of varying stiffness between stiff end section 112 and flexible central section 111. Similarly, at the other end 435 of cable 400, a stiff end section 112 can be disposed abutting connector 440 to provide strain relief at that end of the cable, with another transition section 113 of varying stiffness between stiff end section 112 and flexible central section 111. While dashed lines are used in FIG. 4 to indicate regions 111, 112, 113, it should be understood that these regions need not be visually distinct, and the appearance of cable 400 may be uniform along its entire length.

In this example, electronic device 420 has a height (“z”), and it may be desirable to minimize the height z. Integrating strain relief into the cable sleeve can help to accomplish this goal.

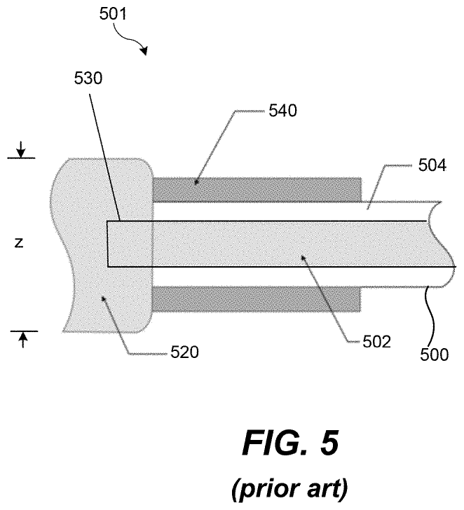

By way of comparison, FIG. 5 shows a simplified cross-section view of an assembly 501 using a conventional strain relief technique. Cable 500 has a core 502 and an outer pliant sleeve 504. One end 530 of cable 500 is captively coupled to an electronic device 520, similarly to the arrangement described above with reference to FIG. 4. As shown, the end of core 502 (or individual wires thereof) can extend through the housing and into the interior of electronic device 520 while the end of sleeve 504 abuts the surface of electronic device 520. Sleeve 504 is made of a flexible material that allows cable 500 to bend. Strain relief is provided by placing an external strain relief sleeve 540 around the end portion of sleeve 504 abutting the housing of electronic device 520. Strain relief sleeve 540 can be made of the same material as the rest of sleeve 504 or a different (e.g., stiffer) material. In either case, strain relief sleeve 540 locally increases the diameter of cable 500, which may require a designer to increase the z-height of electronic device 520 so that cable 500 is not thicker than electronic device 520.

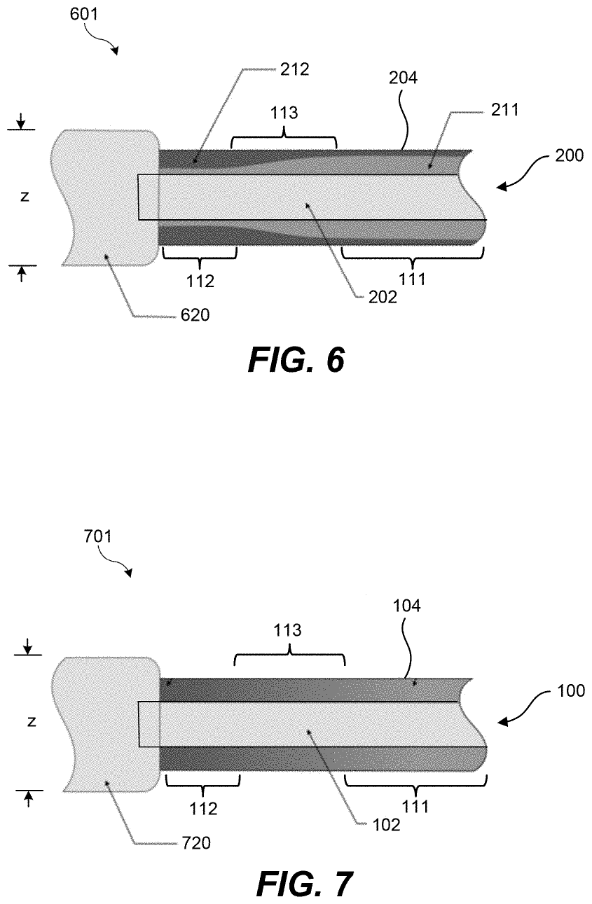

In contrast, cables according to various embodiments described herein can provide strain relief without an external strain relief sleeve or increased cable thickness. FIG. 6 shows a simplified cross section view of an assembly 601 according to some embodiments. Cable 200 (as described above with reference to FIG. 2) has a core 202 and an outer sleeve 204. Outer sleeve 204 includes a stiff layer 212 and a soft layer 211 having variable thicknesses to provide longitudinal sections 112, 112, 113 having different stiffness as described above, while the total thickness of outer sleeve 204 remains constant along its length. Stiff end section 112 abuts the housing of electronic device 620, and transition section 113 provides a gradual transition from stiff end section 112 to flexible central section 111, thereby providing strain relief without locally increasing the diameter of cable 200. Where the minimum z-height of electronic device 620 is constrained by the cable diameter, the absence of an external strain relief sleeve may allow for a reduced height of electronic device 620 as compared to electronic device 520 of FIG. 5.

Similarly, FIG. 7 shows a simplified cross section view of an assembly 701 according to some embodiments. Cable 100 (as described above with reference to FIG. 1) has a core 102 and an outer sleeve 104. Outer sleeve 104 includes a variable mixture of soft and stiff materials to provide longitudinal sections 112, 112, 113 having different stiffness as described above, while the total thickness of outer sleeve 104 remains constant along its length. Stiff end section 112 abuts the housing of electronic device 720, and transition section 113 provides a gradual transition from stiff end section 112 to flexible central section 111, thereby providing strain relief without locally increasing the diameter of cable 100. Where the minimum z-height of electronic device 720 is constrained by the cable diameter, the absence of an external strain relief sleeve may allow for a reduced height of electronic device 720 as compared to electronic device 520 of FIG. 5.

While the invention has been described with reference to specific embodiments, those skilled in the art with access to the present disclosure will appreciate that variations and modifications are possible. For example, while the examples shown include cables where the stiff regions are at the ends, it may be desirable to have one or more stiff regions disposed at other locations along the length of the cable in addition to or instead of at the ends. Accordingly, a stiff section need not be at the end of a cable, and a soft region can be at the end of the cable. Similarly, the lengths of stiff and soft regions can be varied as desired. The length of a transition region can also be varied. In some embodiments, the length of the transition region can be similar to the length of a neighboring stiff region (e.g., the same length or half as long or twice as long). Where the cable sleeve is formed from multiple layers, any number of layers of material can be used, including materials having different stiffness characteristics, and the order of layers can be chosen according to various considerations such as durability. Further, while the foregoing description makes reference to extrusion processes for fabricating a cable sleeve, other processes can also be used.

Cables of the kind described herein can be used in a variety of applications. Examples include power and/or data transfer cables for consumer electronic devices. The ends of the cable can be captively coupled into an active electronic device or into a connector (e.g., a plug-type connector) to allow the cable to be plugged into a device such as a power supply or any active electronic device. In some embodiments, a cable may include one or more optical fibers or other optical signal conductors in addition to or instead of electrically conductive wires or other electrical signal conductors.

Accordingly, although the invention has been described with respect to specific embodiments, it will be appreciated that the invention is intended to cover all modifications and equivalents within the scope of the following claims.

What is claimed is:

1. A cable comprising:
a cable core comprising one or more signal conductors; and
an outer sleeve surrounding the cable core, the outer sleeve having a uniform thickness and further having a first longitudinal section having a first stiffness, a second longitudinal section having a second stiffness, and a third longitudinal section between the first and second longitudinal sections, wherein the second stiffness is greater than the first stiffness and wherein a stiffness of the third longitudinal section varies between the first stiffness and the second stiffness.

2. The cable of claim 1 wherein the second stiffness corresponds to a rigid cable and the first stiffness corresponds to a flexible cable.

3. The cable of claim 1 wherein the second longitudinal section is an end section of the cable.

4. The cable of claim 1 wherein the signal conductors include one or more electrically conductive wires.

5. The cable of claim 1 wherein the outer sleeve comprises a first layer made of a soft material and a second layer made of a stiff material and wherein:
in the first longitudinal section, a thickness of the first layer exceeds a thickness of the second layer;
in the second longitudinal section, the thickness of the second layer exceeds the thickness of the first layer; and
a total thickness of the outer sleeve is constant along the length of the cable.

6. The cable of claim 5 wherein the first layer is inboard of the second layer.

7. The cable of claim 5 wherein the second layer is inboard of the first layer.

8. The cable of claim 5 wherein, in the third longitudinal section, the thickness of the first layer and the thickness of the second layer vary along the length of the third longitudinal section such the total thickness of the outer sleeve is constant.

9. The cable of claim 1 wherein the outer sleeve is formed of a mixed material comprising a stiff polymer and a soft polymer and wherein:
in the first longitudinal section, the mixed material contains a first ratio of the stiff polymer to the soft polymer,
in the second longitudinal section, the mixed material contains a second ratio of the stiff polymer to the soft polymer, the first ratio being lower than the second ratio; and
in the third longitudinal section, the mixed material contains a ratio of the stiff polymer to the soft polymer that varies along the length of the third longitudinal section.

10. A cable comprising:
a cable core comprising one or more electrically conductive wires; and
an outer sleeve surrounding the cable core, the outer sleeve having a uniform thickness and further having a central section having a first stiffness, an end section at each end having a second stiffness, and a transition section between each end section and the central section, wherein the second stiffness is greater than the first stiffness and wherein a stiffness of the transition section varies between the first stiffness and the second stiffness.

11. The cable of claim 10 wherein the second stiffness corresponds to a rigid cable and the first stiffness corresponds to a flexible cable.

12. The cable of claim 10 wherein the outer sleeve comprises a first layer made of a soft material and a second layer made of a stiff material and wherein:
in the central section, a thickness of the first layer exceeds a thickness of the second layer;
in each end section, the thickness of the second layer exceeds the thickness of the first layer; and
a total thickness of the outer sleeve is constant along the length of the cable.

13. The cable of claim 12 wherein the second layer is inboard of the first layer.

14. The cable of claim 12 wherein, in each transition section, the thickness of the first layer and the thickness of the second layer vary along the length of the transition section such the total thickness of the outer sleeve is constant.

15. The cable of claim 14 wherein the outer sleeve is formed of a mixed material containing a stiff polymer and a soft polymer and wherein:
in the central section, the mixed material contains a first ratio of the stiff polymer to the soft polymer,
in each end section, the mixed material a second ratio of the stiff polymer to the soft polymer, the first ratio being lower than the second ratio; and
in each transition section, the mixed material contains a ratio of the stiff polymer to the soft polymer that varies along the length of the transition section.

16. An assembly comprising:
an electronic component having a housing; and
a cable disposed outside the housing, the cable including:
a cable core comprising one or more electrically conductive wires that extend through the housing and couple to the electronic component; and
an outer sleeve surrounding the cable core, the outer sleeve having a uniform thickness and further having a central section having a first stiffness, an end section abutting the housing and having a second stiffness, and a transition section between the central section and the end section, wherein the second stiffness is greater than the first stiffness and wherein a stiffness of the transition section varies between the first stiffness and the second stiffness.

17. The assembly of claim 16 wherein the second stiffness corresponds to a rigid cable and the first stiffness corresponds to a flexible cable.

18. The assembly of claim 16 wherein the outer sleeve comprises a first layer made of a soft material and a second layer made of a stiff material and wherein:
in the end section, a thickness of the first layer exceeds a thickness of the second layer;
in the central section, the thickness of the second layer exceeds the thickness of the first layer; and
a total thickness of the outer sleeve is constant along the length of the cable.

19. The assembly of claim 18 wherein, in the transition section, the thickness of the first layer and the thickness of the second layer vary along the length of the transition section such the total thickness of the outer sleeve is constant.

20. The assembly of claim 16 wherein the outer sleeve is formed of a mixed material containing a stiff polymer and a soft polymer and wherein:
in the central section, the mixed material contains a first ratio of the stiff polymer to the soft polymer,
in the end section, the mixed material contains a second ratio of the stiff polymer to the soft polymer, the first ratio being lower than the second ratio; and
in the transition section, the mixed material contains a ratio of the stiff polymer to the soft polymer that varies along the length of the transition section.
